(19) United States
(12) Patent Application Publication
(10) Pub. No.: US 2019/0314769 A1
(43) Pub. Date: Oct. 17, 2019

(54) BILAYER 2D MATERIAL LAMINATES FOR HIGHLY SELECTIVE AND ULTRA-HIGH THROUGHPUT FILTRATION

(71) Applicant: University of Florida Research Foundation, Inc., Gainesville, FL (US)

(72) Inventor: Saeed Moghaddam, Gainesville, FL (US)

(21) Appl. No.: 16/382,851

(22) Filed: Apr. 12, 2019

Related U.S. Application Data
(60) Provisional application No. 62/657,086, filed on Apr. 13, 2018.

(51) Int. Cl. B01D 69/14; B01D 67/00; B01D 69/02; B01D 71/02; B01D 71/60

(52) U.S. Cl. CPC B01D 69/144; B01D 67/0044; B01D 69/02; B01D 69/10; B01D 71/60; B01D 2325/02; B01D 2325/08; B01D 71/024

(57) ABSTRACT

Various examples are provided for highly selective and ultra-high throughput filtration using bilayer two-dimensional (2D) material laminates and highly absorptive medium of 2D material laminates or solution dispersions. In one example, a 2D material bilayer membrane includes a first membrane layer; an interlinking layer of interlinking molecules disposed on the first membrane layer; and a second membrane layer disposed on the interlinking layer. The interlinking molecules electrostatically or covalently interlink the second membrane layer and first membrane layer.

### CROSS REFERENCE TO RELATED APPLICATIONS

This application claims priority to, and the benefit of, co-pending U.S. provisional application entitled “Bilayer 2D Material Laminates for Highly Selective and Ultra-High Throughput Filtration” having Ser. No. 62/657,086, filed Apr. 13, 2018, which is hereby incorporated by reference in its entirety.

### BACKGROUND

The human body has multiple methods to clear toxins and metabolic products from the bloodstream. Patients with end-stage liver and kidney disease as well as acute organ failure are unable to maintain this necessary clearance and require blood-purification techniques or organ transplant. Due to the limited availability of suitable organ donors and the health of potential recipients, end stage renal disease (ESRD) patients receive regular hemodialysis (HD) treatments in the United States. A smaller number receive artificial liver support therapy for detoxification and liver failure. These blood purification techniques place an extremely high financial burden on the medical system with sometimes questionable efficacy.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram illustrating an example of an idealized structure for GO, in accordance with various embodiments of the present disclosure.

FIG. 1B is a schematic diagram illustrating an example of an assembly of nanoplatelets, in accordance with various embodiments of the present disclosure.

FIG. 2A is a schematic diagram illustrating an example of a 2D material bilayer using an interlinker, in accordance with various embodiments of the present disclosure.

FIG. 2B is a schematic diagram illustrating an example of a sequential process for GO bilayer fabrication, in accordance with various embodiments of the present disclosure.

FIGS. 3A and 3B are plots illustrating examples of preliminary retention and rejection data for GO-PAN-PAH membrane for ibuprofen, in accordance with various embodiments of the present disclosure.

FIGS. 4A, 4B and 4C are schematic diagrams illustrating examples of removal of water-soluble and albumin-bound toxins through dialysis and adsorption using 2D material bilayers, in accordance with various embodiments of the present disclosure.

FIG. 5 is a schematic diagram illustrating an example of a dispersion adsorption cartridge, in accordance with various embodiments of the present disclosure.

FIG. 6A is an image showing an example of a porous membrane made to support GO bilayer assembly, in accordance with various embodiments of the present disclosure.

FIGS. 6B and 6C are images showing examples of GO flakes assembled on the support membrane of FIG. 6A, in accordance with various embodiments of the present disclosure.

FIG. 7A-7C are images showing an example of the membrane assembly of FIG. 6C bonded on a microchannel device, in accordance with various embodiments of the present disclosure.

### DETAILED DESCRIPTION

Disclosed herein are various examples related to highly selective and ultra-high throughput filtration using bilayer two-dimensional (2D) material laminates and highly absorptive medium of 2D material laminates or solution dispersions. Reference will now be made in detail to the description of the embodiments as illustrated in the drawings, wherein like reference numbers indicate like parts throughout the several views.

Development of a high throughput and selective membrane technology and a highly absorptive medium with a small volume can help alleviate the high financial burdens of dialysis on patients. A high throughput membrane enables fabrication of a membrane module substantially smaller than the existing technology leading to significant reduction in extracorporeal blood volume. In a typical dialysis session, a person losses 150 ml of blood. Given that a dialysis patient is treated three times a week, the existing technology results in loss of 400-500 ml of blood per week. This is the blood that leaves the patient body to the pipes and membrane module, and is not recovered. Some dialysis patients suffer from anemia. A compact microchannel dialysis cartridge with only several ml of blood volume can alleviate this issue. Such a compact membrane cartridge can be installed on patient's body (e.g. forearm) such that only the dialysate fluid connections need to be connected to a machine. Such a breakthrough can alleviate bleeding concerns associated with access to blood vessels in home-based dialysis. Currently, home-based dialysis accounts for only a very small fraction of total dialysis patients.

Current dialyzers utilize hollow-fiber membranes that have remained relatively unchanged for decades. While significant effort has been made to introduce a portable or wearable artificial kidney (WAK), the existing designs utilize conventional but miniaturized HD components, which necessitates extended use and requires qualified patients. The fundamental challenge is that despite many years of system engineering, operation principle and transport characteristics of the membranes utilized in these systems have remained the same. To address patients' safety concerns and enhance affordability in US and throughout the world, innovative membrane improvements to facilitate toxin removal at low operating flow rates are required. Lower flow rates would enable new vascular access options, to reduce the risk of exsanguination.

Like HD, liver support systems have also been slow to change, utilizing similar dialyzer approaches in combination with often dated adsorption technologies such as activated charcoal and anion exchange columns. Patients receiving artificial liver support receive a fundamentally similar dialysis treatment, but with the goal of removing albumin-bound and lipophilic toxins. This clearance is primarily accomplished through albumin dialysis and/or use of an adsorption column. In both cases, toxin clearance is transport-limited by either the dialyzer membrane or entrance into the adsorptive matrix.

Nano-engineered 2D material laminates and dispersions have the potential to radically improve and change hemodialysis and liver support systems. 2D materials bilayers are the thinnest possible molecular sieve and have tunable physical and surface chemical properties to allow selective clearance of small and middleweight toxins. Additionally, nanoscale spaced 2D materials sheets offer the maximal surface area of any material matrix per unit volume enabling unparalleled adsorptive properties, with extremely high permeability. Preparation and characterization of a 2D material (e.g., graphene oxide (GO)) membrane is presented in “Proton selective ionic graphene-based membrane for high concentration direct methanol fuel cells” by Paneri et al. (Journal of Membrane Science 467 (May 2014) 217-225), which is hereby incorporated by reference in its entirety. These properties would dramatically improve the flexibility to design medical devices that improve survival and quality of life, while reducing cost.

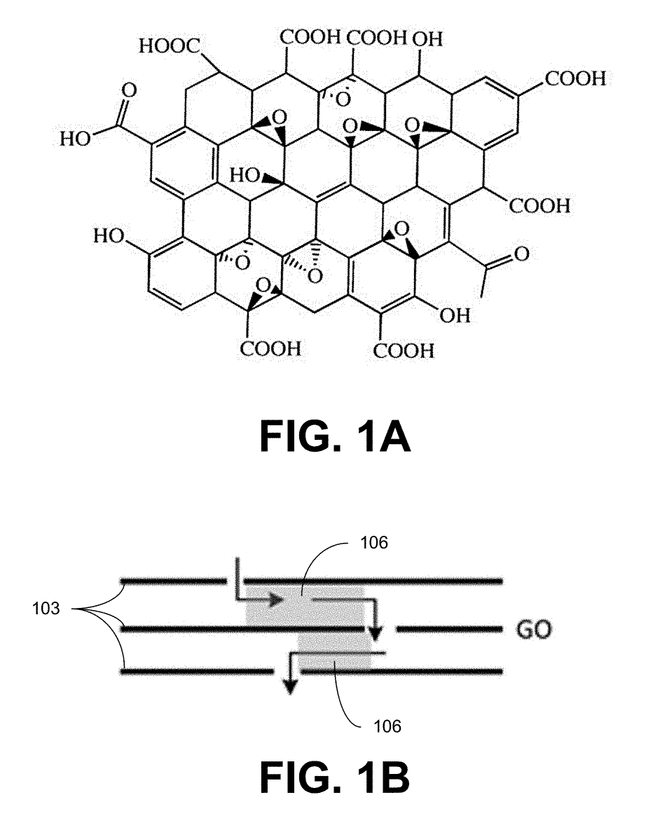

An example of the 2D material (GO) is an atomically-thin functionalized derivative of graphene, comprising a carbon backbone with several oxygen-containing groups (e.g., epoxy, hydroxyl, carboxyl, carbonyl) on the basal plane and edges. FIG. 1A illustrates an example of an idealized structure for GO. Due to its functional groups, the GO surface can be extensively modified with numerous molecules. Parameters such as surface charge polarity and/or density, and/or hydrophilic and/or hydrophobic characteristics of the GO surface can be changed through grafting and molecular self-assembly. Studies have shown that GO laminates exhibit high water permeation rates. Referring to FIG. 1B, shown is an example of an assembly of GO nanoplatelets 103 illustrating a unique transport characteristic that, unlike other membranes that have a range of pore sizes, a bottle-neck (shaded area 106) can be formed between two GO platelets 103 giving a precise molecular size cut-off. The effective sieve size that a GO laminate presents has been studied and found it to be about 9 Å under aqueous conditions. This interlayer spacing can be adjusted using different size interlinking molecules.

Through a comprehensive study, it has been shown that i) the laminate thickness, ii) nanoplatelets size, iii) surface defects and iv) the inter-layer spacing vastly impact the GO laminates permeability and selectivity. See “Impact of synthesis conditions on physicochemical and transport characteristics of graphene oxide laminates” by Paneri et al. (CARBON 86 (January 2015) 245-255), which is hereby incorporated by reference in its entirety. In the application of GO for reduction of undesirable methanol permeation through a proton exchange membrane (PEM), an order of magnitude better performance was achieved compared to prior studies when the synthesis process of the GO platelets was precisely controlled. Other benefits of GO membranes in dialysis have also been confirmed. In a fundamentally different approach than disclosed here, a composite membrane was made by adding up to 2% GO into a polymer matrix. The addition of the GO into the polymer matrix increased the membrane mean pore size from 32 nm to 76 nm, which increased its permeability. However, the membrane exhibited an increase in biocompatibility: reduced protein adsorption, suppressed platelet adhesion, and lower complement activation.

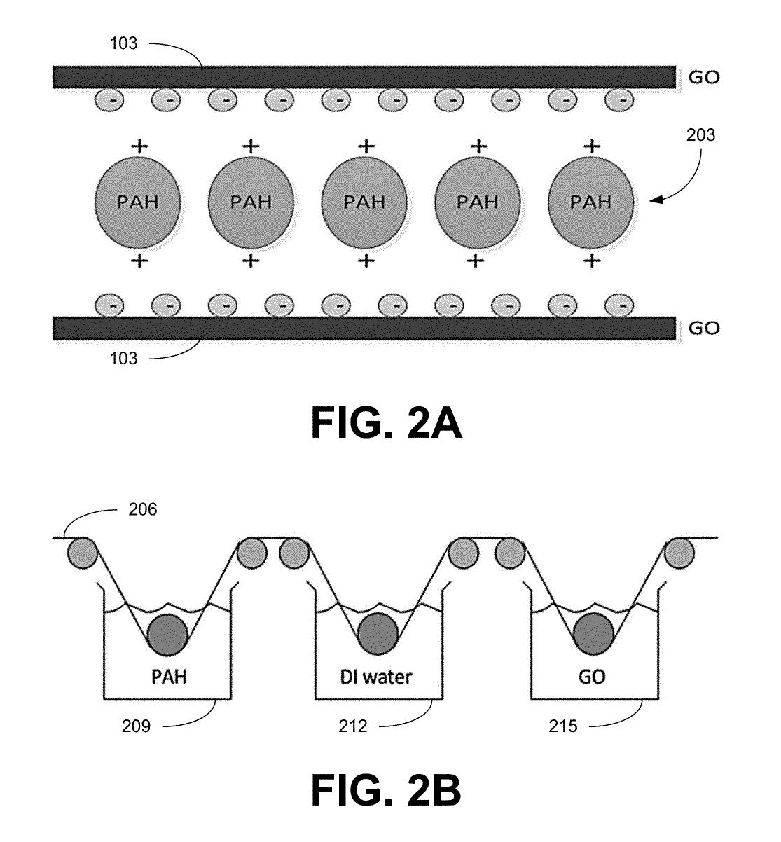

Here, GO bilayers with a precise control on the interlayer spacing can be produced through layer-by-layer (L-b-L) assembly of GO platelets 103 on a porous polymer support in a highly scalable process. FIG. 2A illustrates an example of a GO bilayer using PAH as an interlinker 203. The graphene-oxide (GO) bilayer provides a highly selective and efficient 2D material for separation processes in many applications. The membrane is an order of magnitude thinner than the active layer of existing NF membranes (100-200 nm). Individual GO flakes or platelets are interlinked electrostatically or covalently using cross-linker (or interlinking) molecules. The membrane selective characteristics can be controlled based on the spacing between the layers.

FIG. 2B schematically depicts an example of a sequential process in which the polymer support 206 is soaked in different baths containing the GO platelets and the interlinking molecules. As shown in the scalable synthesis method of FIG. 2B, the support 206 can pass through a bath of an interlinking molecule such as, e.g., PAH 209, a bath of deionized (DI) water 212, and a bath of GO 215 to produce the GO laminates. The soaking process can be repeated as desired to achieve the desired number of bilayers.

In terms of material cost, the disclosed configuration can be very economical. Mass production of graphene has improved in recent years due to the large number of potential graphene-based applications. Production of graphene has increased from 15 tons in 2010 to 120 tons in 2014, with the price of graphene being estimated at $1.50/gr. Depending on the number of GO layers, 100s of square meters of a typical polymer support membrane 206 can be covered with a bilayer structure using 1 gr of GO. Therefore, the cost of graphene does not contribute to the overall cost of the membrane, and the cost is dominated by a set of batch chemical processes. The cost of these chemical processes is not substantially different than those used in the fabrication of existing dialysis and ultrafiltration membranes.

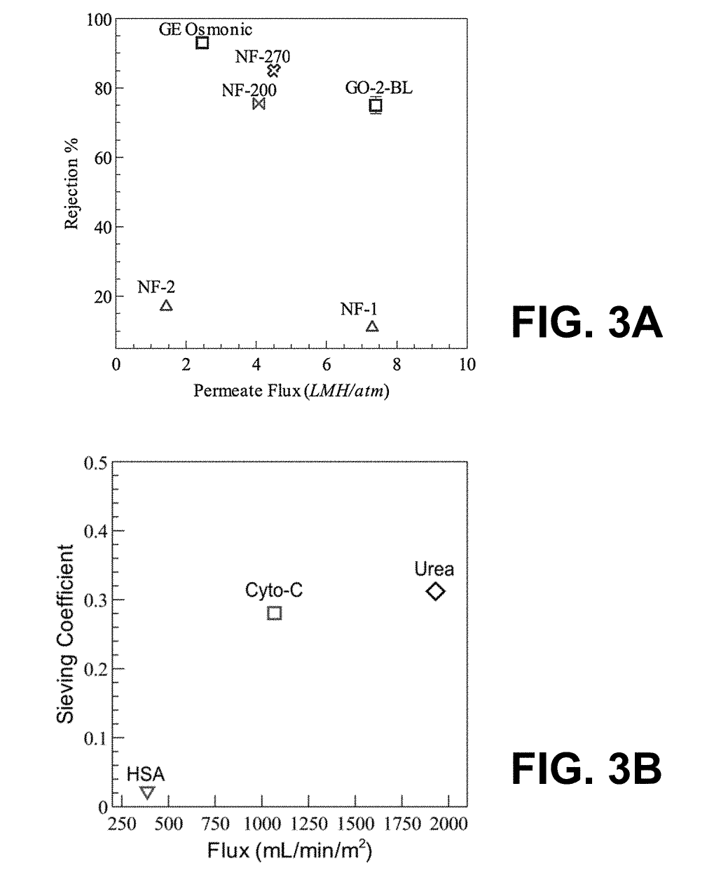

In a preliminary test, a molecular assembly of GO nanoplatelets 103 on a polyacrylonitrile (PAN) support membrane 206 was prepared. After hydrolyzing the optimized PAN membrane 206, the L-b-L assembly was conducted to build the GO laminate. Poly(allylamine hydrochloride) (PAH) was used as the interlinking molecule 203. For testing, a 0.2 mM solution of Ibuprofen was supplied to a diffusion cell and the permeated solution was collected and analyzed. For the purpose of comparison, a GE Osmonics membrane was also tested in the same setup. The results were compared with literature data on other membranes and plotted in FIG. 3A, which illustrates preliminary rejection data for GO-PAN-PAH membrane for ibuprofen. The preliminary tests showed that the GO based membrane (GO-2-BL) permeability, without any optimization, was substantially better than all other membranes. The experience with optimizing the performance of a proton exchange membrane, as mentioned before, suggests that the membrane performance can be improved by a few orders of magnitude with optimization of the GO nanoplatelets physicochemical properties and interlayer spacing. FIG. 3B shows data collected for human serum albumin (HSA), cyto-c and urea using a membrane with 200 nm pores. The sieving of urea and cyto-c is expected to increase to 70-80% using a support with 50 nm pores.

The use of nanoengineered 2D laminates and dispersions for the clearance of water-soluble and albumin-bound toxins offers two-fold advantages. First, these materials reduce the needed membrane area by at least an order of magnitude compared to the state-of-the-art, based on thicknesses <10 nm and an increased permeability. In addition, nanospaced 2D laminates offer a theoretical limit on accessible surface area within a fixed volume that is likely to exceed conventional materials by orders of magnitude.

Development and optimization of membranes can include alteration of the physical “pore” size and the surface chemistry.

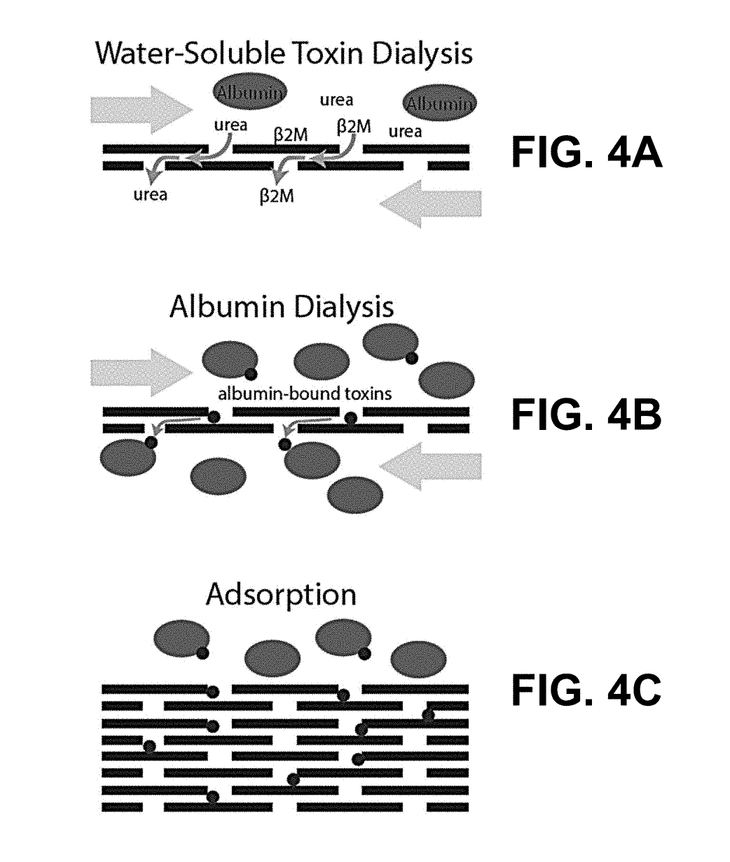

Referring now to FIG. 4A, shown is a schematic diagram of a GO membrane for removal of water-soluble toxins through dialysis. The oxidation level, nanoplatelets size, defects size and density, and the interlinking molecules can affect the membrane permeability and selectivity. These parameters can be varied to find the optimal membrane design. The interlayer spacing plays the key role in the membrane rejection performance and the permeate flow length determines the membrane permeability. Ideally, the nanoplatelets should be assembled in such a way that edges and defects of the GO stack are quite close without overlapping.

Using the interlinking molecules, the interlayer spacing can be varied from about 1 nm to about 10 nm and can impact the performance of the membrane. This can be accomplished using PAH and/or poly(dimethyldiallylammonium chloride) (PDDAC) with different molecular weights. PAH can be chemically derived from poly(allylamine phosphate) (PAP), which can be synthesized by solution polymerization of allylamine phosphate (AP) using 2,2′-azo-bis-2-amidinopropane dihydrochloride (AAP.2HCl) as the initiator. Following its synthesis, the PAP can be reacted with concentrated hydrochloric acid to obtain the PAH. Furthermore, smaller covalent linkers such as multivalent metal ions, 1,3,5-benzenetricarbonyl trichloride, and diamine monomers may be utilized. These are non-limiting examples, many other molecules and polymer chains can be used.

The size of GO nanoplatelets can be measured using the Langmuir-Blodgett method and subsequently imaged using a Scanning Electron Microscope (SEM) (e.g., FEI Nova NanoSEM 430) in conjunction with image analysis software (e.g., ImageJ software) to analyze the SEM images. X-ray Diffraction (XRD) (e.g., X′Pert Powder) measurements can be conducted to determine the interlayer spacing of the GO laminates in a dry state. Fourier Transform Infrared Spectroscopy (FTIR) can be used to determine the number of GO bilayers within the laminate while Atomic Force Microscopy (AFM) (e.g., Dimension 3100) can be used to measure the thickness and surface morphologies.

Referring now to FIGS. 4B and 4C, shown are schematic diagrams of GO membranes for removal of albumin-bound toxins through dialysis and adsorption. In order to achieve clearance of albumin-bound toxins from plasma, an albumin dialysis system (FIG. 4B) with the smallest possible GO membrane can be produced to reduce bilirubin concentration. A nanospaced stacked GO adsorption matrix system (FIG. 4C) or dispersion can be used to reduce bilirubin concentration. The surface chemistry of GO allows for specific addition of various molecules to achieve desired surface properties for a given application.

Selection of the best-suited amine or other surface molecule can be determined during the optimization and sieving characterization process. X-ray Photoelectron Spectroscopy (XPS) (e.g., Perkin Elmer 5100) can be employed to evaluate the surface chemistry of GO with Transmission Electron Micrograph (TEM) (e.g., JEM-ARM200CF) determining the GO surface features. Raman spectra (e.g., Horiba LabRAM ARAMIS) can be used to analyze any inhomogeneity developed during GO synthesis. The surface charge of a GO laminate can be tested using a zeta-potential analyzer (e.g., Zetaplus, TA Instruments). For evaluation, simulated plasma can comprise PBS plus 4.0 g/dL HSA and 20 mg/dL bilirubin. Solutions can be incubated overnight prior to dialysis in order to reach bilirubin conjugation equilibrium with HSA. The dialysate can initially comprise 20% HSA to match current commercial systems. For example, the circulation volumes can be 140 mL plasma and 2 mL albumin-rich dialysate in order to match the ratio used by the Gambro MARS® system.

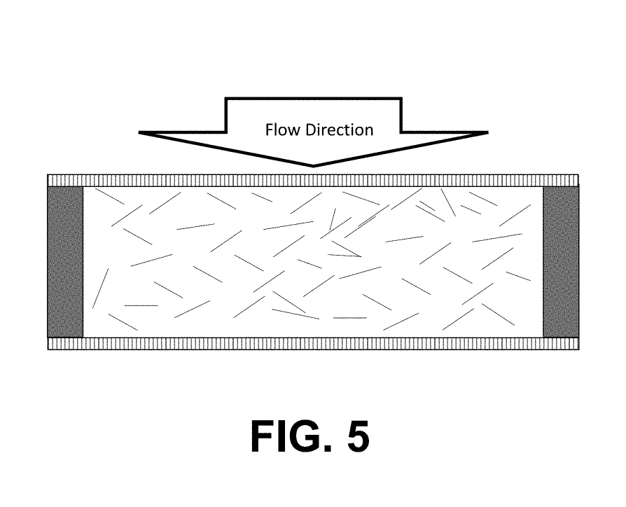

FIG. 5 is a schematic diagram illustrating an example of a dispersion adsorption cartridge including a 2D material adsorption bed. A low-cost stabilized dispersion of functional 2D material nanoplatelets can provide filtration and detoxification functions of kidney and liver. This may be accomplished by packaging the solution between two membranes that are permeable to plasma and impermeable to nanoplatelets (e.g., one atomic layer thick but microns wide).

The effectiveness of a GO-based albumin dialysis system to easily release lipophilic species to the albumin dialysate may be adjusted by modifying the GO surface properties such as hydrophobicity, hydrophilicity and surface charge density. In some implementations, the nanospaced GO stack or dispersion may be engineered as an albumin permeable membrane with spacing that rejected larger species (MW>100 kD, D>7 nm) such as immunoglobulin. Albumin-bound and lipophilic toxins can be adsorbed to the GO matrix releasing cleansed albumin in the filtrate, which could then be reintroduced with the blood.

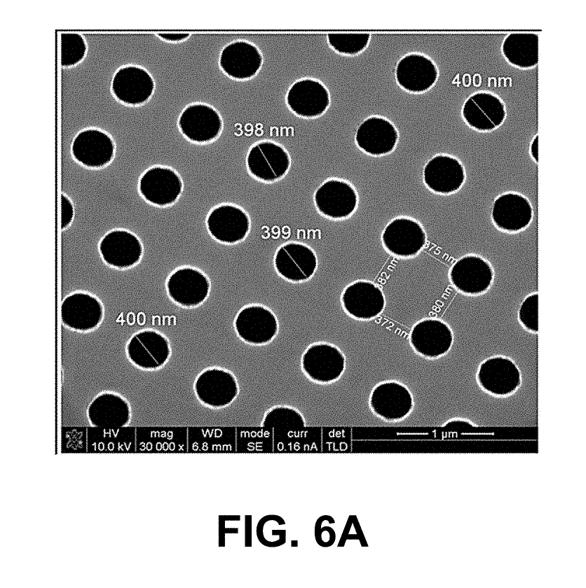

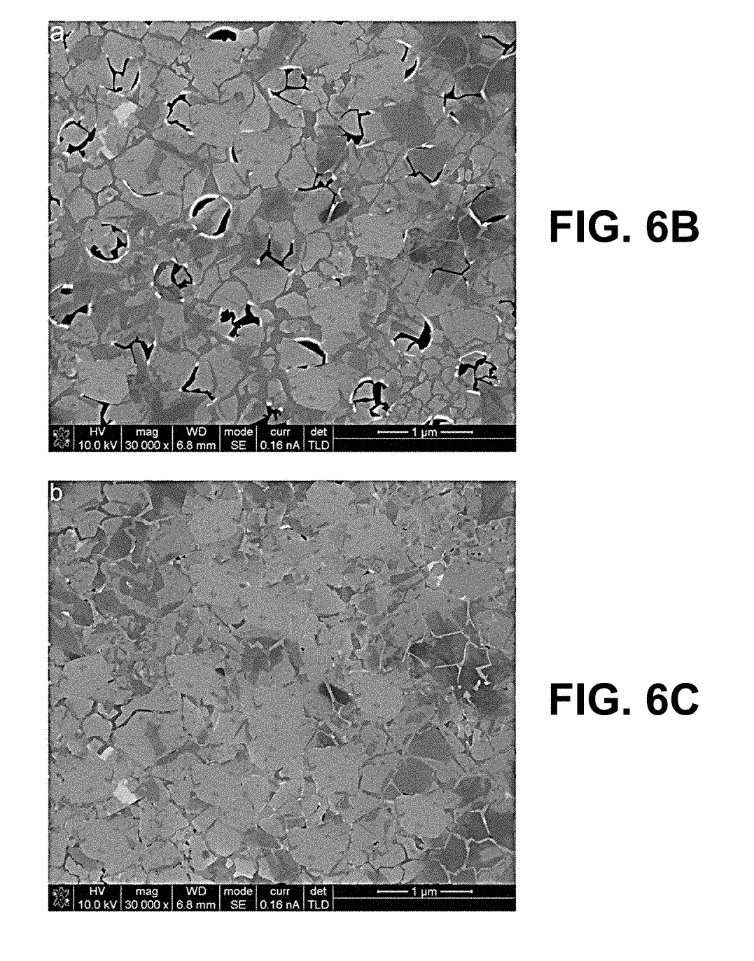

Referring to FIG. 6A, shown is an example of a support membrane (e.g., a porous polymer layer) that can be used to support the bilayer structure. The scanning electron microscope (SEM) image of FIG. 6A illustrates a membrane with a pore size (diameter) of about 400 nm. Other membranes have been fabricated with pore sizes (diameters) of about 200 nm and about 100 nm. Pore size (diameter) can be, e.g., in a range from about 800 nm to about 30 nm, about 750 nm to about 30 nm, from about 750 to about 50 nm, from about 600 nm to about 50 nm, from about 600 nm to about 100 nm, from about 500 nm to about 50 nm, from about 500 nm to about 100 nm, or from about 400 nm to about 100 nm. The pores can be separated by, e.g., about the diameter of the pores. In the example of FIG. 6A, the pores are separated by about 375-380 nm or about 377 nm. Other ranges of separation can be used.

Reducing the pore size and/or separation distance between pores decreases the path length between layers as illustrated in FIG. 1B. It also increases porosity because smaller flakes can be used. The experimental data shows a consistent increase in membrane permeability. The SEM image of FIG. 6B shows a first GO layer (with PAH interconnect) atop the support membrane. The pores of the membrane are visible below the flakes. The SEM image of FIG. 6C shows three GO layers atop the support membrane with 400 nm pores. Note that there are pores within the flakes.

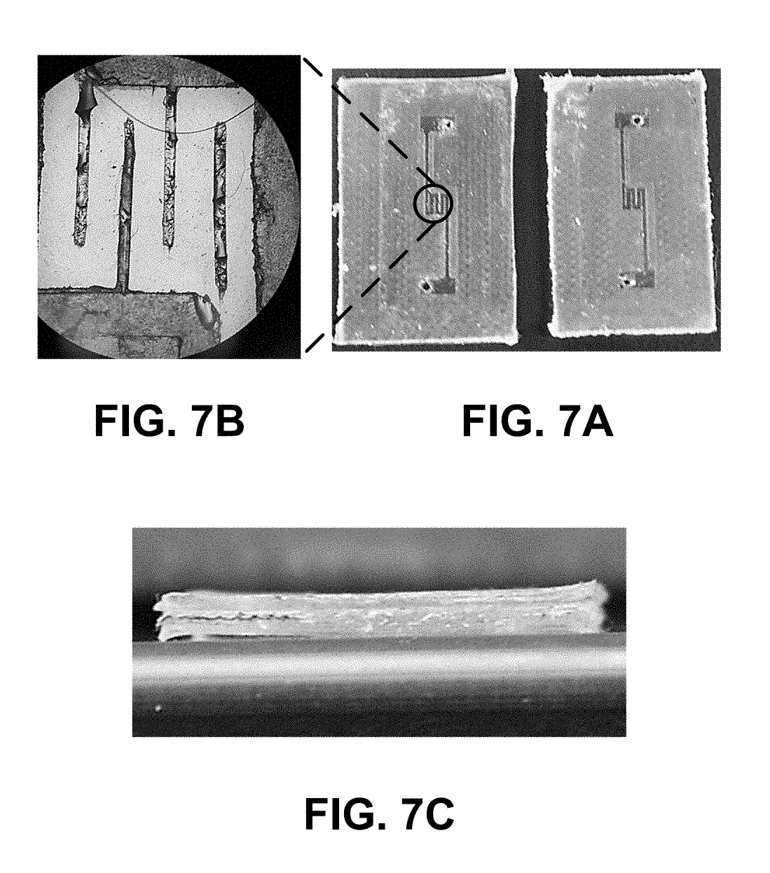

FIGS. 7A-7C illustrate an example of a membrane structure bonded over microchannels. FIG. 7A is an image of two small fabricated channel layers, with FIG. 7B being an SEM image of a microchannel in one of the layers. Larger devices can include thousands of microchannels in each channel layer. As shown in the side view of FIG. 7C, the second microchannel covers the membrane and forms a device. The microchannels are aligned on opposite sides of the bilayer membrane. Blood passes through one channel while dialysate fluid passes through other. Urea and Creatinine pass through the membrane to dialysate fluid.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that materials, ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A 2D material bilayer membrane, comprising:
a first membrane layer;
an interlinking layer of interlinking molecules disposed on the first membrane layer; and
a second membrane layer disposed on the interlinking layer, where the interlinking molecules electrostatically or covalently interlink the second membrane layer and first membrane layer.

2. The 2D material bilayer membrane of claim 1, wherein a spacing between the first and second membrane layers is determined by the interlinking molecules.

3. The 2D material bilayer membrane of claim 2, wherein the spacing is based upon the molecular weight of the interlinking molecules.

4. The 2D material bilayer membrane of claim 1, wherein the interlinking molecules consist of poly(allylamine hydrochloride) (PAH).

5. The 2D material bilayer membrane of claim 1, wherein the interlinking molecules comprise poly(dimethyldiallylammonium chloride) (PDDAC).

6. The 2D material bilayer membrane of claim 1, wherein the interlinking molecules electrostatically or covalently interlink with platelets of the second membrane layer.

7. The 2D material bilayer membrane of claim 6, wherein the platelets comprise nanoplatelets.

8. The 2D material bilayer membrane of claim 6, wherein a surface chemistry of the platelets is modified by the addition of a modification molecule.

9. The 2D material bilayer membrane of claim 8, wherein the modification molecule is amine.

10. The 2D material bilayer membrane of claim 8, wherein the modification to the surface chemistry includes a modification to surface charge polarity, surface charge density, hydrophilicity or hydrophobicity.

11. The 2D material bilayer membrane of claim 6, wherein the platelets comprise graphene oxide (GO) platelets.

12. The 2D material bilayer membrane of claim 1, wherein the first membrane layer is a porous polymer layer.

13. The 2D material bilayer membrane of claim 12, wherein the porous polymer layer is a synthesized or patterned layer.

14. The 2D material bilayer membrane of claim 1, wherein the first membrane layer comprises platelets.

15. A 2D material bilayer membrane structure, comprising:
a first channel layer comprising a first fluid channel;
a 2D material bilayer membrane disposed on the first channel layer over the first fluid channel; and
a second channel layer comprising a second fluid channel, the second channel layer disposed on the 2D material bilayer membrane opposite the first channel layer with the second fluid channel aligned with the first channel layer.

16. The 2D material bilayer membrane structure of claim 15, wherein the 2D material bilayer membrane comprises layers of platelets electrostatically or covalently interlinked by interlinking molecules.

17. The 2D material bilayer membrane structure of claim 16, wherein the platelets comprise graphene oxide (GO) platelets.

18. The 2D material bilayer membrane structure of claim 16, wherein a surface chemistry of the platelets is modified by the addition of a modification molecule.

19. The 2D material bilayer membrane structure of claim 16, wherein the layers of platelets are disposed on a porous support membrane.

20. The 2D material bilayer membrane structure of claim 15, wherein the first and second channels are microchannels.
